(19) United States
(12) Patent Application Publication
(10) Pub. No.: US 2018/0075467 A1
(43) Pub. Date: Mar. 15, 2018

(54) METHODS AND APPARATUS FOR IDENTIFYING AND CLASSIFYING CUSTOMER SEGMENTS

(71) Applicant: MASTERCARD INTERNATIONAL INCORPORATED, Purchase, NY (US)

(72) Inventor: Rakesh Tiwari, Delhi (IN)

(21) Appl. No.: 15/696,621

(22) Filed: Sep. 6, 2017

(30) Foreign Application Priority Data
Sep. 14, 2016 (SG) 10201607648W

(51) Int. Cl. G06Q 30/02; G06Q 40/00

(52) U.S. Cl. CPC G06Q 30/0204; G06Q 30/0226; G06Q 40/12

(57) ABSTRACT

A computer implemented method of identifying and classifying customer segments is disclosed. The method comprises: receiving customer purchase history data for a plurality of payment cards of a payment card account type associated with a merchant organization, the customer purchase history data comprising indications of transactions carried out by customers using the payment cards of the payment card account type at the merchant organization; grouping the customers into a plurality of customer segments using the purchase history data; receiving payment card accounting data for the payment card account type, the payment card accounting data comprising indications of accounting data associated with the payment card account type; calculating a revenue value for each customer segment of the plurality of customer segments; and classifying the customer segments according to the revenue value.

### TECHNICAL FIELD AND BACKGROUND

The present disclosure relates to methods and apparatus for processing financial transaction data. In particular, it provides methods and apparatus for identifying and classifying customer segments using financial transaction data.

Transaction data can provide valuable insights for businesses. A business may use such insights to target promotions or offers to key customer groups. Further such insights may allow businesses to assess the effectiveness of such promotions and offers.

Many payment card issuers have co-branding arrangements with merchants such as retailers. Under such arrangements payment cards such as credit cards are issued by the payment card issuer with a loyalty points or similar tie-in to a retailer. In the analysis of transactions by cardholders of co-branded payment cards, the targets of the issuing organization and the merchant may be different. For example, the merchant may wish to increase sales revenue whereas the issuing organization may be focused on increasing revenue from financial services.

Current customer segmentation techniques used in analyzing financial transactions generally focus on either the merchant view or the financial services revenue view.

### SUMMARY

In general terms, the present disclosure proposes methods and apparatus for identifying and classifying customer segments using data relating to both purchases at a merchant associated with a merchant and accounting data for such a payment card.

According to a first aspect, there is provided a computer implemented method of identifying and classifying customer segments. The method comprises receiving, in a customer segment identification and classification server, customer purchase history data for a plurality of payment cards of a payment card account type associated with a merchant organization, the customer purchase history data comprising indications of transactions carried out by customers using the payment cards of the payment card account type at the merchant organization; grouping, in a customer segmentation module of the customer segment identification and classification server, the customers into a plurality of customer segments using the purchase history data; receiving, in the customer segment identification and classification server, payment card accounting data for the payment card account type, the payment card accounting data comprising indications of accounting data associated with the payment card account type; calculating a revenue value for each customer segment of the plurality of customer segments in a revenue value calculation module of the customer segment identification and classification server; and classifying the customer segments according to the revenue value in a customer segment classification module of the customer segment identification and classification server.

In some embodiments, grouping the customers into a plurality of segments using the purchase history data comprises determining a value for each of a plurality of loyalty attributes for each customer from the purchase history data; determining a score for each customer from the loyalty attributes and grouping the customers into a plurality of segments using the score for each customer.

In some embodiments, determining a score for each customer from the loyalty attributes comprises, for each loyalty attribute, determining a group for the customer based on the value for that loyalty attribute, determining a weight based on the group for the customer and determining the score by combining the weights from the plurality of loyalty attributes.

The score may be determined as the sum of the weights from the plurality of loyalty attributes.

In some embodiments, the groups for the customers are based on quantiles of the values for each of the plurality of loyalty attributes.

The loyalty attributes may comprise one or more of the following: length of relationship between the customer and the merchant organization; redemption of loyalty or reward points by the customer; frequency of visits by the customer to the merchant organization; average basket size of purchases by the customer at the merchant organization; and number of repeat items purchased by the customer at the merchant organization.

According to a second aspect, there is provided an apparatus for identifying and classifying customer segments. The apparatus comprises: a computer processor and a data storage device, the data storage device having a customer segmentation module; a revenue value calculation module and a customer segment classification module comprising non-transitory instructions operative by the processor to: receive customer purchase history data for a plurality of payment cards of a payment card account type associated with a merchant organization, the customer purchase history data comprising indications of transactions carried out by customers using the payment cards of the payment card account type at the merchant organization; group the customers into a plurality of customer segments using the purchase history data; receive payment card accounting data for the payment card account type, the payment card accounting data comprising indications of accounting data associated with the payment card account type; calculate a revenue value for each customer segment of the plurality of customer segments; and classify the customer segments according to the revenue value.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram illustrating entities involved in processing a transaction;

FIG. 2 is a block diagram illustrating the entities involved in a transaction involving a payment card affiliated with a merchant;

FIG. 3 is a block diagram showing a data processing apparatus according to an embodiment of the present invention;

FIG. 4 is a block diagram showing a technical architecture of a data processing apparatus according to an embodiment of the present invention; and

FIG. 5 is a flowchart showing a method of identifying and classifying customer segments according to an embodiment of the present invention.

### DETAILED DESCRIPTION

As used herein, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

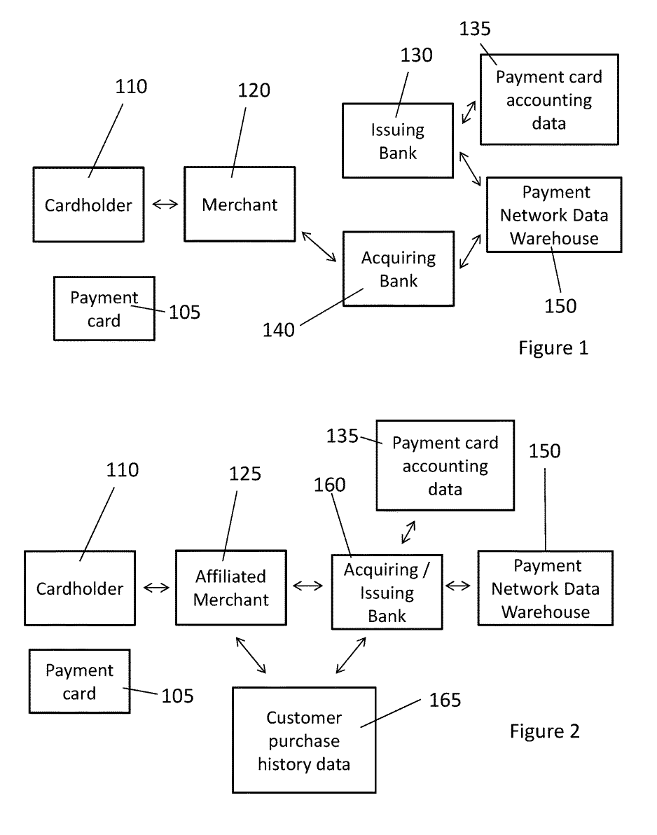

FIG. 1 illustrates the entities involved in processing a typical transaction. As shown in FIG. 1, a cardholder 110 and a merchant 120 initiate a transaction. The cardholder 110 uses a payment card 105 in the transaction. The transaction may involve the purchase of goods from the merchant 120 by the cardholder 110. In order to process the transaction, information concerning the transaction is transferred to an issuing bank 130 and an acquiring bank 140. The issuing bank 130 holds details of an account in the name of the cardholder 110 and the acquiring bank 140 holds details of an account in the name of the merchant 120. In order to process the transaction, the issuing bank 130 and the acquiring bank 140 exchange information to authorize and execute the transaction. This information exchange takes place through a payment network. Both the issuing bank 130 and the acquiring bank provide information to a payment network data warehouse 150 which stores information on transactions carried out using the payment network.

The issuing bank 130 stores payment card accounting data 135. The payment card accounting data 135 comprises details of the transactions carried out using the payment card 105 and other payment cards of the same type. The payment card accounting data 135 includes details of income made by the issuing bank 130 from the payment card 105. This income may include interest income charged to the cardholder 110; interchange fees charged to merchants for transactions carried out using the payment card 105; and annual fees paid by the cardholder 110. The payment card accounting data also includes details of costs associated with the payment card 105. These costs may include operation costs such as the salary of staff at the issuing bank 130 who are responsible for administration of the payment card accounts and advertising costs associated with the payment card; the costs also include risk related losses due to defaults on debt owed on credit cards; and provisioning costs associated with capital that the issuing bank 130 has to keep to cover potential losses.

The payment network data warehouse may be implemented as a server coupled to one or more databases storing data. The server may be configured to handle requests and/or communications from terminals associated with parties involved in a transaction carried out over the payment network. The payment network can be any electronic payment network which connects, directly and/or indirectly payers (consumers and/or their banks or similar financial institutions) with payees (the merchants and/or their banks or similar financial institutions). Non-limiting examples of the payment network are a payment card type of network such as the payment processing network operated by MasterCard, Inc. The various communication may take place via any types of network, for example, virtual private network (VPN), the Internet, a local area and/or wide area network (LAN and/or WAN), and so on.

FIG. 2 illustrates the entities involved in a transaction involving a payment card affiliated with a merchant. As shown in FIG. 2, a cardholder 110 having a payment card 105 initiates a transaction with an affiliated merchant 125. The affiliated merchant 125 together with an issuing bank provide the co-branded payment card 105. As shown in FIG. 2, the issuing bank may also act as the acquiring bank and thus the two entities as shown as an acquiring/issuing bank 160.

In order to process the transaction, information concerning the transaction is transferred to the acquiring/issuing bank 160. The acquiring/issuing bank holds both details of an account in the name of the cardholder 110 and details of an account in the name of the affiliated merchant 125. The acquiring/issuing bank 160 provides information to the payment network data warehouse 150 which stores information on transactions carried out using the payment network. The affiliated merchant 125 and/or the acquiring/issuing bank 160 store customer purchase history data 165. The customer purchase history data 165 may include details of purchases such as the times and dates that purchases were made and the items purchased. The customer purchase history data 165 may also include loyalty card information such as details of loyalty reward points earned and/or redeemed by the cardholder 110. The acquiring/issuing bank 160 also stores payment card accounting data 135 as described above in relation to FIG. 1.

As described above, for transactions carried out at an affiliated merchant, additional information may be available to the merchant and the issuing bank; however for transactions at other merchants this information is not available. For all transactions however, payment card accounting data will be available.

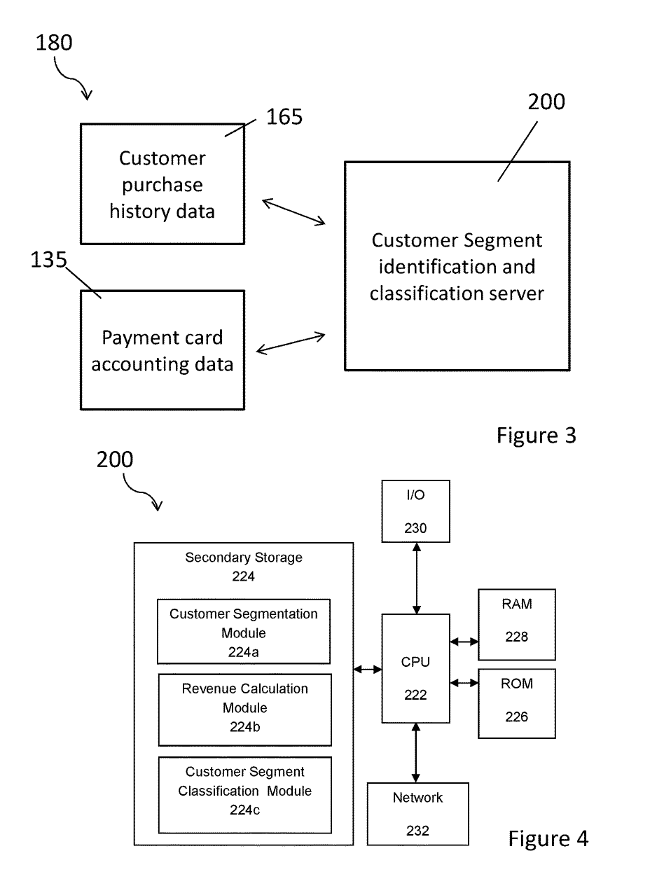

FIG. 3 shows a data processing apparatus according to an embodiment of the present invention. The data processing apparatus 180 comprises a customer segment identification and classification server 200. The customer segment identification and classification server 200 is coupled to a database storing payment card accounting data 135 and a database storing customer purchase history data 165. The payment card accounting data 135 is collected and stored as described above with reference to FIGS. 1 and 2. The customer purchase history data 165 is collected and stored as described above in relation to FIG. 2.

The customer segment identification and classification server 200 analyses the payment card accounting data 135 and the customer purchase history data 165 to group customers into segments and to classify the segments according to their profitability.

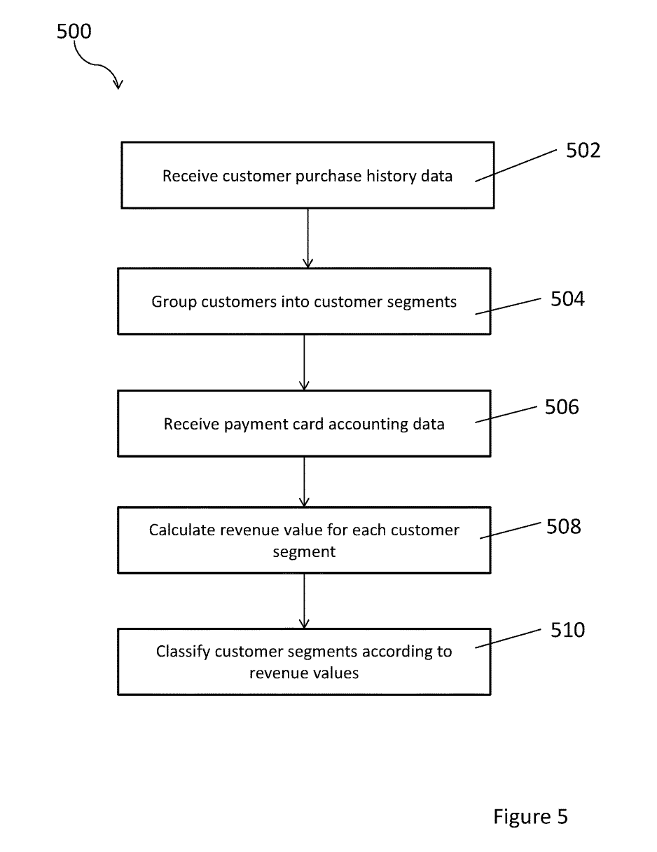

FIG. 4 is a block diagram showing a technical architecture of the customer segment identification and classification server 200 for performing an exemplary method 500 which is described below with reference to FIG. 5. Typically, the method 500 is implemented by a computer having a data-processing unit. The block diagram as shown FIG. 4 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a customer segmentation module 224a, a revenue value calculation module 224b and a customer segment classification module 224c comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 500 will now be described with reference to FIG. 5 in respect of identification and classification of customer segments. It should be noted that enumeration of operations is for purposes of clarity and that the operations need not be performed in the order implied by the enumeration.

FIG. 5 shows a method of identifying and classifying customer segments according to an embodiment of the present invention. The method 500 is carried out by the customer segment identification and classification server 200 described above.

In step 502, the customer segment identification and classification server 200 receives customer purchase history data 165. The customer purchase history data 165 comprises indications of purchases by customers at the merchant affiliated with the payment card. The customer purchase history data may also include indications of loyalty or reward program membership of the customers. For example, the customer purchase history data may include indications of when customers joined the loyalty or reward program; and their use of the loyalty or reward program such as loyalty points earned and redeemed. The customer purchase history data 165 may also include indications of the products and/or services purchased by the customer, for example as stock keeping unit (SKU) identifiers of the individual products and/or services.

In step 504, the customer segmentation module 224a of customer segment identification and classification server 200 groups the customers into customer segments using the purchase history data.

Step 504 may be implemented by customer segmentation module 224a of customer segment identification and classification server 200 determining a plurality of loyalty attributes for the customers. Examples of possible loyalty attributes are the length of the customer relationship with the affiliated merchant and/or the issuing bank; reward points redemption by the customer; the frequency of visits by the customer to the affiliated merchant; the basket size of transactions made by the customer at the affiliated merchant; and the number of repeat items purchased by the customer at the affiliated merchant.

In step 504, the customer segmentation module 224a of customer segment identification and classification server 200 may calculate the loyalty attributes from the purchase history data and then for each loyalty attribute determine a weight. The weights may be determined by dividing the possible values for the loyalty attributes into a plurality of buckets or quantiles such as deciles. Each of the buckets could then be assigned a weight.

For example, if one of the loyalty attributes is the length of the customer relationship, customers could be placed in buckets based on the length of the relationship with the affiliated merchant, for example customer with a relationship longer than 10 years could be placed in a first bucket; customers with a relationship length of less than 10 years but more than 8 years could be placed in a second bucket; customers with a relationship length of less than 8 years but more than 6 years in a third bucket; customers with a relationship length of 5 to 6 years in a fourth bucket; customers with a relationship length of 4 to 5 years in a fifth bucket; customers with a relationship length of 3 to 4 years in a sixth bucket; customer with a relationship length of 2 to 3 years in a seventh bucket; customers with a relationship length of 1 to 2 years in an eighth bucket; customers with a relationship length of 6 months to 1 year in a ninth bucket and customers with a relationship length of less than 6 months in a tenth bucket. In this example the longer relationship lengths may be assigned a greater weight.

A score for the customer may then be calculated from the weights. The score may be calculated as the sum of the weights from each of the loyalty attributes being considered. In some embodiments the sum may be weighted so that certain attributes have a larger effect on the customer score.

The customers are then segmented based on the scores. The customer segments are based on the loyalty attributes and therefore the difference customer segments determined in step 504 have different loyalty characteristics.

In step 506, the customer segment identification and classification server 200 receives payment card accounting data 135. As described above, the payment card accounting data 135 includes indications of the revenue generated from customers and the costs associated with payment card accounts. The payment card accounting data received in step 506 may relate to a fixed time period such as 12 months.

In step 508, the revenue value calculation module 224b of customer segment identification and classification server 200 calculates revenue values for each of the customer segments using the payment card accounting data 135.

Step 508 allows account level profitability to be calculated for each of the customer segments.

In step 510, the customer segments are classified according to the revenue values calculated in step 508. Step 510 may involve identifying the most profitable customer segments and ranking the segments in order of profitability. Alternately step 510 may involve determining a profitability or revenue per customer for each segment in terms of a benchmark or average value.

Whilst the foregoing description has described exemplary embodiments, it will be understood by those skilled in the art that many variations of the embodiment can be made within the scope and spirit of the present invention.

1. A computer implemented method of identifying and classifying customer segments, the method comprising:
receiving, in a customer segment identification and classification server, customer purchase history data for a plurality of payment cards of a payment card account type associated with a merchant organization, the customer purchase history data comprising indications of transactions carried out by customers using the payment cards of the payment card account type at the merchant organization;
grouping, in a customer segmentation module of the customer segment identification and classification server, the customers into a plurality of customer segments using the purchase history data;
receiving, in the customer segment identification and classification server, payment card accounting data for the payment card account type, the payment card accounting data comprising indications of accounting data associated with the payment card account type;
calculating a revenue value for each customer segment of the plurality of customer segments in a revenue value calculation module of the customer segment identification and classification server; and
classifying the customer segments according to the revenue value in a customer segment classification module of the customer segment identification and classification server.

2. A method according to claim 1, wherein grouping the customers into a plurality of segments using the purchase history data comprises: determining a value for each of a plurality of loyalty attributes for each customer from the purchase history data; determining a score for each customer from the loyalty attributes; and grouping the customers into a plurality of segments using the score for each customer.

3. A method according to claim 2, wherein determining a score for each customer from the loyalty attributes comprises: for each loyalty attribute, determining a group for the customer based on the value for that loyalty attribute; determining a weight based on the group for the customer; and determining the score by combining the weights from the plurality of loyalty attributes.

4. A method according to claim 3, wherein the score is determined as the sum of the weights from the plurality of loyalty attributes.

5. A method according to claim 3, wherein the groups for the customers are based on quantiles of the values for each of the plurality of loyalty attributes.

6. A method according to claim 2, wherein the loyalty attributes comprise one or more of the following: length of relationship between the customer and the merchant organization; redemption of loyalty or reward points by the customer; frequency of visits by the customer to the merchant organization; average basket size of purchases by the customer at the merchant organization; and number of repeat items purchased by the customer at the merchant organization.

7. A non-transitory computer readable medium having stored thereon processor executable instructions which when executed on a processor cause the processor to perform a method comprising:
receiving customer purchase history data for a plurality of payment cards of a payment card account type associated with a merchant organization, the customer purchase history data comprising indications of transactions carried out by customers using the payment cards of the payment card account type at the merchant organization;
grouping the customers into a plurality of customer segments using the purchase history data;
receiving payment card accounting data for the payment card account type, the payment card accounting data comprising indications of accounting data associated with the payment card account type;
calculating a revenue value for each customer segment of the plurality of customer segments; and
classifying the customer segments according to the revenue value.

8. A non-transitory computer readable medium according to claim 7, wherein the executable instructions are configured to further cause the processor to: group the customers into a plurality of segments using the purchase history data by determining a value for each of a plurality of loyalty attributes for each customer from the purchase history data; determine a score for each customer from the loyalty attributes; and group the customers into a plurality of segments using the score for each customer.

9. A non-transitory computer readable medium according to claim 8, wherein determining a score for each customer from the loyalty attributes comprises: for each loyalty attribute, determining a group for the customer based on the value for that loyalty attribute; determining a weight based on the group for the customer; and determining the score by combining the weights from the plurality of loyalty attributes.

10. A non-transitory computer readable medium according to claim 9, wherein the score is determined as the sum of the weights from the plurality of loyalty attributes.

11. A non-transitory computer readable medium according to claim 9, wherein the groups for the customers are based on quantiles of the values for each of the plurality of loyalty attributes.

12. A non-transitory computer readable medium according to claim 8, wherein the loyalty attributes comprise one or more of the following: length of relationship between the customer and the merchant organization; redemption of loyalty or reward points by the customer; frequency of visits by the customer to the merchant organization; average basket size of purchases by the customer at the merchant organization; and number of repeat items purchased by the customer at the merchant organization.

13. An apparatus for identifying and classifying customer segments comprising:
a computer processor and a data storage device, the data storage device having a customer segmentation module, a revenue value calculation module and a customer segment classification module comprising non-transitory instructions operative by the processor to:
receive customer purchase history data for a plurality of payment cards of a payment card account type associated with a merchant organization, the customer purchase history data comprising indications of transactions carried out by customers using the payment cards of the payment card account type at the merchant organization;
group the customers into a plurality of customer segments using the purchase history data;
receive payment card accounting data for the payment card account type, the payment card accounting data comprising indications of accounting data associated with the payment card account type;
calculate a revenue value for each customer segment of the plurality of customer segments; and
classify the customer segments according to the revenue value.

14. An apparatus according to claim 13, wherein the customer segmentation module comprises non-transitory instructions operative by the processor to: group the customers into a plurality of segments using the purchase history data by determining a value for each of a plurality of loyalty attributes for each customer from the purchase history data; determine a score for each customer from the loyalty attributes; and group the customers into a plurality of segments using the score for each customer.

15. An apparatus according to claim 14, wherein determining a score for each customer from the loyalty attributes comprises: for each loyalty attribute, determining a group for the customer based on the value for that loyalty attribute; determining a weight based on the group for the customer; and determining the score by combining the weights from the plurality of loyalty attributes.

16. An apparatus according to claim 15, wherein the score is determined as the sum of the weights from the plurality of loyalty attributes.

17. An apparatus according to claim 15, wherein the groups for the customers are based on quantiles of the values for each of the plurality of loyalty attributes.

18. An apparatus according to claim 14, wherein the loyalty attributes comprise one or more of the following: length of relationship between the customer and the merchant organization; redemption of loyalty or reward points by the customer; frequency of visits by the customer to the merchant organization; average basket size of purchases by the customer at the merchant organization; and number of repeat items purchased by the customer at the merchant organization.
